(19) United States
(12) Patent Application Publication
(10) Pub. No.: US 2007/0214904 A1
(43) Pub. Date: Sep. 20, 2007

(54) Double-clutch transmission

(75) Inventor: Ulrich Ohnemus, Hattenhofen (DE)

Correspondence Address: CROWELL & MORING LLP;INTELLECTUAL PROPERTY GROUP, P.O. BOX 14300, WASHINGTON, DC, 20044-4300, US

(73) Assignee: BAYERISCHE MOTOREN WERKE AKTIENGESELLSCHAFT, Muenchen (DE)

(21) Appl. No.: 11/798,309

(22) Filed: May 11, 2007

Related U.S. Application Data
(63) Continuation of application No. PCT/EP06/00489, filed on Jan. 20, 2006.

(30) Foreign Application Priority Data
Feb. 10, 2005 (DE) 10 2005 005 942.2

(51) Int. Cl. F16H 3/08

(52) U.S. Cl. 74/330

(57) ABSTRACT

A double-clutch transmission for vehicles is described. The device has a driveshaft and an output shaft, a first transmission input shaft coaxial with a second transmission input shaft, which may be hollow. A first clutch is provided, used to coupled the driveshaft to the first transmission input shaft, and a second clutch, used to couple the driveshaft to the second transmission input shaft. A first, second, third, and fourth gearwheel step are provided, as well as an intermediate drive, which is driven by the first or the second transmission input shaft via one of the gearwheel steps as a function of the shift state of the gearwheel steps. The first transmission input shaft is assigned to the first and the second gearwheel steps, and the second transmission input shaft is assigned to the third and the fourth gearwheel steps.

### CROSS REFERENCE TO RELATED APPLICATIONS

This application is a continuation of PCT International Application No. PCT/EP2006/000489, filed Jan. 20, 2006, which claims priority under 35 U.S.C. § 119 to German Patent Application No. 10 2005 005 942.2 filed Feb. 10, 2005, the entire disclosures of which are herein expressly incorporated by reference.

### BACKGROUND AND SUMMARY OF THE INVENTION

The present invention relates to a double-clutch transmission for vehicles having a drive shaft, output shaft, first and second transmission input shaft, and first and second clutches respectively coupled to the first and second input shafts.

Double-clutch transmissions have been known for some time. They allow shifting without interruption of traction and therefore come into consideration for sport-oriented vehicles in particular. Double-clutch transmissions have two transmission input shafts, one of which is typically implemented as a hollow shaft and the other of which is implemented as a solid shaft, which is situated in the hollow shaft. The two input shafts are each assigned to a first or second “partial transmission,” respectively. For example, typically the forward gears 1, 3, 5 are driven via the first input shaft and the forward gears 2, 4, 6 are driven via the second input shaft. Furthermore, a driveshaft is provided, which is alternately coupled via a first clutch with the first transmission input shaft or via a second clutch with the second transmission input shaft. When shifting from one gear into the next higher or next lower gear, one clutch is opened and the other is simultaneously closed, so that the drive torque delivered by the driveshaft may be “transferred” from one partial transmission to the other partial transmission without interruption of traction. Double-clutch transmissions are, for example, known from DE 198 50 549 A1.

To be able to drive with the most optimum possible consumption in different operating states of the vehicle, the transmission is to have the largest possible transmission spread. The term “transmission spread” is understood to mean the gear ratio range of the transmission, i.e., the ratio between the largest gear ratio value and the smallest gear ratio value. The transmission is thus to have a creep gear having a higher gear ratio for very low velocities as well as one or more gears which are provided for “overdrive operation.” “Overdrive operation” is understood to mean that the engine is operated at full load power, but the vehicle does not reach its highest velocity. An overdrive gear thus has a smaller gear ratio than the gear in which the vehicle reaches its highest velocity. For example, it is conceivable that a vehicle equipped with a 5-gear transmission reaches its highest velocity in the 4^{th} gear and the 5^{th} gear is designed as the overdrive gear. An overdrive gear is preferably to be designed so that it still has a relatively high acceleration torque.

If, starting from typical manually shifted transmissions, one wishes to include consumption-relevant “overdrive ranges,” this requires an enlargement of the transmission spread, as already noted. Therefore, the number of the gears must be increased in multistep transmissions. One is typically faced with the problem that if the gear number is increased, the overall volume of the transmission is also enlarged.

The present invention provides a power-shift transmission, which has a large transmission spread, i.e., comparatively many gears, as well as a compact construction, and is simultaneously comfortable to shift.

Benefits of the invention may be achieved according to the exemplary embodiments described below. Additionally, advantageous embodiments and refinements of the present invention may be inferred from the text and drawings below.

The present invention is applicable, for example, to a double-clutch transmission for vehicles. The double-clutch transmission has a driveshaft to be driven by a vehicle engine and an output shaft. The actual transmission has a first and a second transmission input shaft. The second transmission input shaft may be implemented as a hollow shaft. The first transmission input shaft may then be situated in the second transmission input shaft implemented as a hollow shaft. A first clutch and a second clutch are situated between the driveshaft and the two transmission input shafts. By closing the first clutch, the driveshaft may be coupled rotationally fixed to the first transmission input shaft. By closing-the second clutch, the driveshaft may be coupled rotationally fixed to the second transmission input shaft. The double-clutch transmission also has various gearwheel steps, of which initially a first, second, third, and fourth gearwheel step will be described in greater detail. These gearwheel steps are provided for the purpose of transmitting torque from the transmission input shafts to an “intermediate drive.” The intermediate drive is driven by the first or the second transmission input shaft via one of the gearwheel steps, as a function of the switching state of the gearwheel steps. The double-clutch transmission according to an embodiment of the present invention is distinguished in that the first transmission input shaft is assigned to the first and to the second gearwheel steps, and the second transmission input shaft is assigned to the third and to the fourth gearwheel steps.

According to an exemplary refinement of the present invention, the intermediate drive has two shafts, namely a first intermediate shaft implemented as a hollow shaft and a second intermediate shaft which extends through the first intermediate shaft. Each of the two transmission input shafts may be rotationally coupled via two of the above-mentioned gearwheel steps to one of the two intermediate shafts. The first transmission input shaft may thus be coupled via the first or the second gearwheel step to one of the intermediate shafts, as a function of the shift state of the first and second gearwheel steps. Correspondingly, the second transmission input shaft may be coupled via the third or the fourth gearwheel step to one of the intermediate shafts, as a function of the shift state of the third and fourth gearwheel steps.

For example, the first transmission input shaft may be coupled via the first or second gearwheel step to the first intermediate shaft and the second transmission input shaft may be coupled via the third or fourth gearwheel step to the second intermediate shaft.

In a preferred exemplary embodiment, an “intermediate shaft clutch” is provided, which has an opened and a closed shift state. When the intermediate shaft clutch is closed, the two intermediate shafts are rotationally coupled to one another.

Other objects, advantages and novel features of the present invention will become apparent from the following detailed description of the invention when considered in conjunction with the accompanying drawings.

### BRIEF DESCRIPTION OF THE DRAWINGS

In the following, the present invention is explained in greater detail in connection with the drawings.

FIG. 1 shows a schematic drawing of an exemplary embodiment of a double-clutch transmission according to the present invention;

FIG. 2 shows a shift matrix of the double-clutch transmission of FIG. 1;

FIGS. 3-12 show the torque flow in the individual gears of the exemplary embodiment according to the invention; and

FIG. 13 shows a table of the gear ratios and step jumps of the transmission.

### DETAILED DESCRIPTION OF THE DRAWINGS

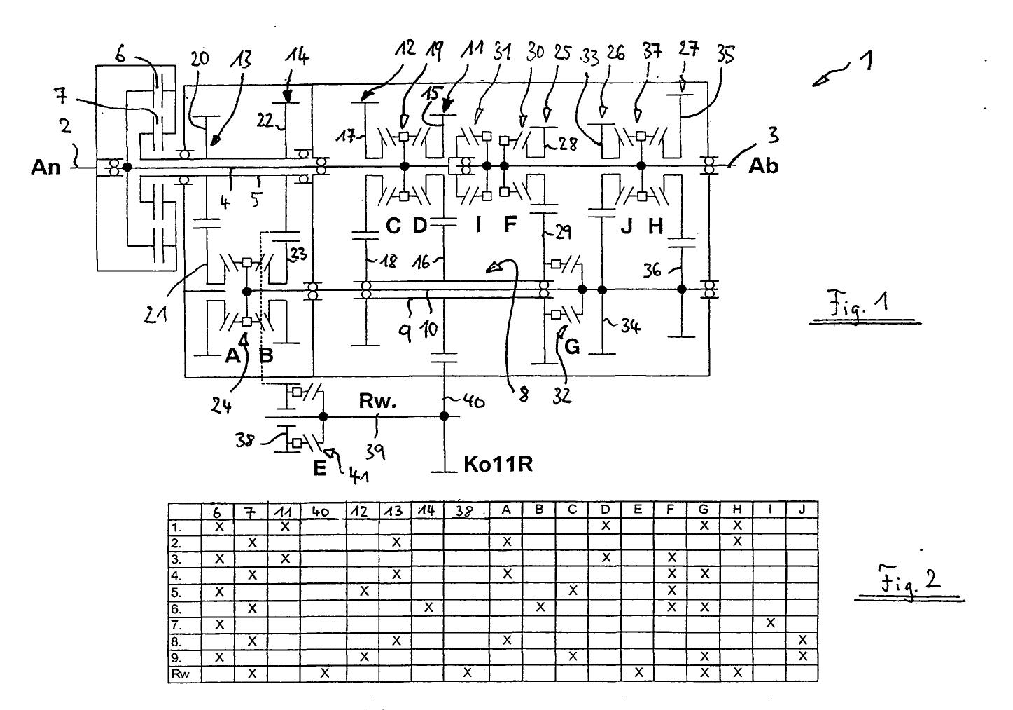

FIG. 1 shows a double-clutch transmission 1, which has a driveshaft 2 and an output shaft 3. The double-clutch transmission 1 also has a first transmission input shaft 4 and a second transmission input shaft 5. The second transmission input shaft 5 is a hollow shaft which is inserted into the first transmission input shaft 4. The two exemplary transmission input shafts 4, 5 are thus situated coaxially to one another. Furthermore, a first clutch 6 and a second clutch 7 are provided. By closing the first clutch 6, the driveshaft 2 is rotationally coupled to the first transmission input shaft 4. By closing the second clutch 7, the driveshaft 2 is rotationally coupled to the second transmission input shaft 5, which is implemented as a hollow shaft.

Furthermore, the exemplary double-clutch drive 1 has an intermediate configuration 8. The intermediate configuration 8 is primarily formed by a first intermediate shaft 9, implemented as a hollow shaft, and a second intermediate shaft 10. The second intermediate shaft 10 is inserted into the first intermediate shaft 9, which is implemented as a hollow shaft. The two intermediate shafts 9, 10 are thus situated coaxially to one another.

As can be seen from FIG. 1, the first transmission input shaft 4 is assigned to a first wheel set 11 and a second wheel set 12. The second transmission input shaft 5 is assigned to a third wheel set 13 and a fourth wheel set 14.

The first wheel set 11 may be formed by a gearwheel 15 mounted on the first transmission input shaft 4 so it is rotatable, and a gearwheel 16 connected rotationally fixed to the first intermediate shaft 9. The second wheel set 12 may be formed by a gearwheel 17 mounted on the first transmission input shaft 4 so it is rotatable, and a gearwheel 18 mounted fixed on the first intermediate shaft 9. Furthermore, a shiftable clutch 19 is situated on the first transmission input shaft 4, which may be implemented, for example, as a sliding sleeve or as a double synchronization. The shiftable clutch 19 may assume three settings, namely alternately a middle neutral setting or a left shift setting, in which it connects the gearwheel 17 rotationally fixed to the transmission input shaft 4, or a right shift setting, in which it connects the gearwheel 15 rotationally fixed to the transmission input shaft 4.

The third wheel set 13 may be formed by a gearwheel 20 connected rotationally fixed to the second transmission input shaft 5 and a rotatably mounted gearwheel 21, which is situated coaxially to the two intermediate shafts 9, 10. The fourth wheel set 14 is formed by a gearwheel 22 connected rotationally fixed to the second transmission input shaft 5, and a gearwheel 23 mounted so it is rotatable on the second intermediate shaft 10. Furthermore, a shiftable clutch 24 is provided, which may also assume three settings, namely a middle neutral setting, a left shift setting, in which it couples the gearwheel 21 rotationally fixed to the second intermediate shaft 10, or a right shift setting, in which it couples the gearwheel 23 rotationally fixed to the second intermediate shaft 10.

On the output side, the exemplary double-clutch transmission 1 also has a fifth wheel set 25, a sixth wheel set 26, and a seventh wheel set 28. The fifth wheel set 26 may be formed by a gearwheel 28 mounted so it is rotatable on the output shaft 3 and a gearwheel 29 connected fixed to the first intermediate shaft 9. The gearwheel 28 may be rotationally coupled to the output shaft 3 via a shiftable clutch 30. Furthermore, a shiftable clutch 31 is provided, via which the first transmission input shaft 4 may be coupled directly to the output shaft 3. Furthermore, a shiftable clutch 32 is provided. When the clutch 32 is opened, the two intermediate shafts 9, 10 may rotate in relation to one another. When the shiftable clutch 32 is closed, the two intermediate shafts 9, 10 are coupled to one another.

The sixth wheel set 26 may be formed by a gearwheel 33 and a gearwheel 34. The gearwheel 33 is situated so it is rotatable on the output shaft 3. The gearwheel 34 is connected rotationally fixed to the second intermediate shaft 10. The seventh wheel set 27 may be formed by a gearwheel 35 mounted so it is rotatable on the output shaft 3 and a gearwheel 36 connected rotationally fixed to the second intermediate shaft 10. A shiftable clutch 37 is assigned to the sixth and seventh wheel sets 26 and 27, which may assume three shift settings, namely a middle neutral setting, a left shift setting, in which the gearwheel 33 is rotationally coupled to the output shaft 3, and a right shift setting, in which the gearwheel 35 is rotationally coupled to the output shaft 3.

For the sake of completeness, reference is also made to a gearwheel 38 working together with the fourth wheel set 14, which is mounted on the shaft 39 so it is rotatable. A gearwheel 40 connected rotationally fixed to the shaft 39 engages with the gearwheel 16. The gearwheel 38 may be rotationally coupled to the shaft 39 via a shiftable clutch 41. The gearwheel 38 working together with the fourth wheel set 14, the shaft 39, and the gearwheel 40 form a reverse gear.

The shift settings of the shiftable clutches 19, 24, 30, 31, 32, 37, 41 are indicated respectively by the capital letters A, B, C, D, E, F, G, H, I, J.

As can be seen from FIG. 1, the double-clutch transmission 1 has seven wheel set levels 11, 12, 13, 14, 25, 26, 27. Using the seven wheel set levels, nine forward gears and one reverse gear may be represented.

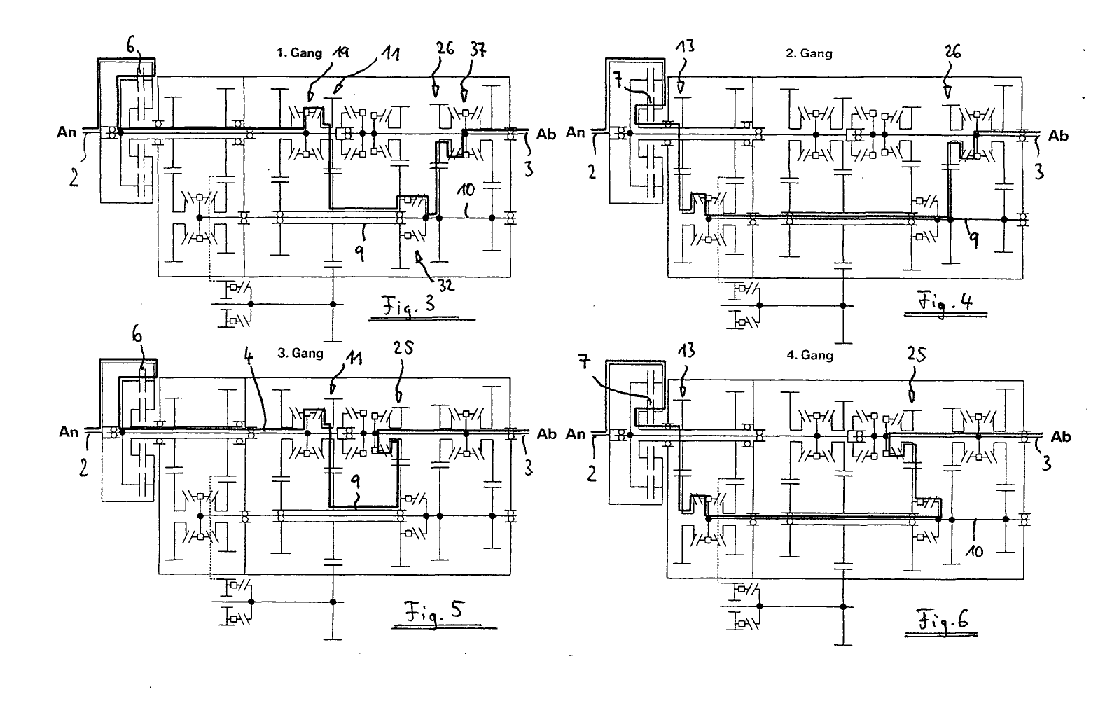

FIG. 2 shows the shift matrix corresponding to the above exemplary transmission. The individual gears 1, 2, 3, 4, 5, 6, 7, 8, 9 and the reverse gear Rw are listed in the first column. The first gear is a creep gear, the second gear is a normal starting gear. The gears 8, 9 are overdrive gears. Depending on the selection of the gear ratio, the gear 7 may also be implemented as an overdrive gear.

The shiftable and/or shifted elements are listed in the first line, i.e., the first and second clutches 6, 7, the first wheel set 11, the gearwheel 40 necessary for providing the reverse gear, the second wheel set 12, the third wheel set 13, the fourth wheel set 14, and the gearwheel 38, which is also necessary for providing the reverse gear. Furthermore, the shift settings A-J of the shiftable clutches 19, 24, 30, 31, 32, 37, and 41 are shown in the first line of the matrix.

The individual shift settings for the exemplary transmission are explained in greater detail in the following.

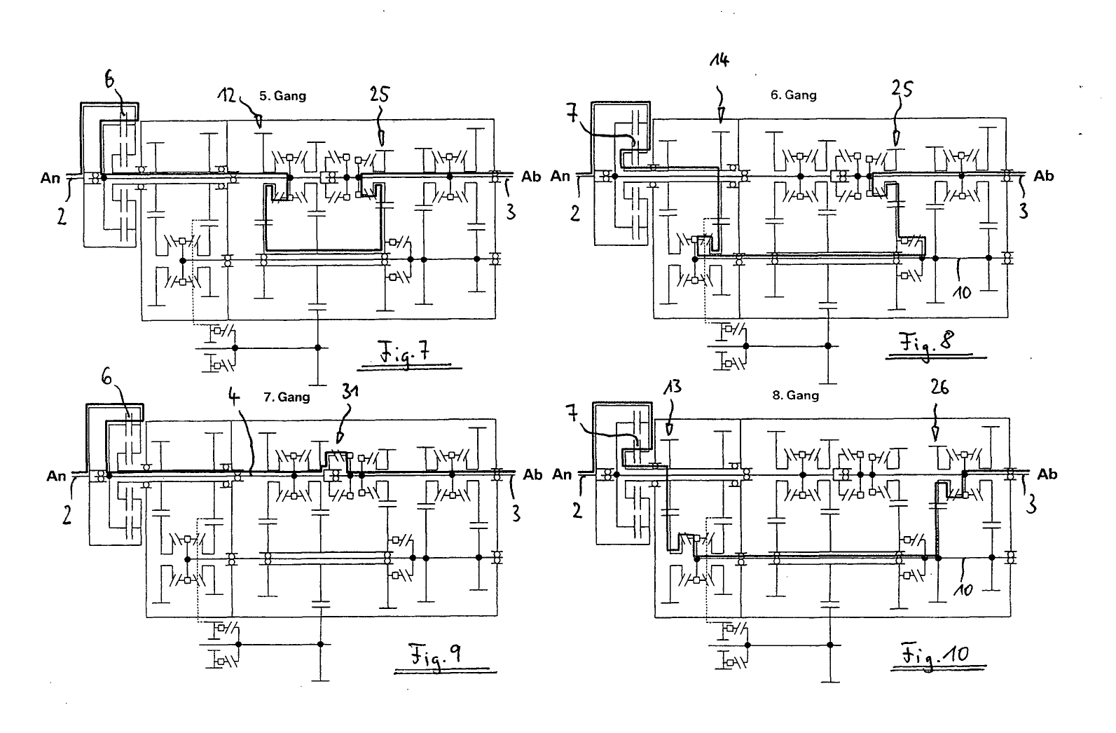

FIG. 3 shows the torque flow when the first gear, designed as a creep gear, is selected. The torque coming from the driveshaft 2 is conducted via the first clutch 6 to the second transmission input shaft 5 and transmitted from there via the shiftable clutch 19 and the wheel set 11 to the first intermediate shaft 9. The torque is transmitted from the first intermediate shaft 9 via the shiftable clutch 32 to the second intermediate shaft 10 and from there via the sixth wheel set 26 and the shiftable clutch 37 to the output shaft 3.

The torque flow for the second gear, designed as a normal starting gear, is shown in FIG. 4. The torque is transmitted from the driveshaft 2 via the second clutch 7 and the third wheel set 13 to the first intermediate shaft 9 and from there via the sixth wheel set 26 to the output shaft 3.

FIG. 5 shows the torque flow for the third gear. The torque is introduced from the driveshaft 2 via the first clutch 6 into the first transmission input shaft 4 and from there via the first wheel set 11, the first intermediate shaft 9, and the fifth wheel set 25 into the output shaft 3.

In the fourth gear, the torque is conducted from the driveshaft 2 via the second clutch 7, the third wheel set 13, the second intermediate shaft 10, and the fifth wheel set 25 to the output shaft 3.

In the fifth gear, the torque is conducted from the driveshaft 2 via the first clutch 6, the second wheel set 12, and the fifth wheel set 25 to the output shaft 3.

In the sixth gear, the torque is conducted from the driveshaft 2 via the second clutch 7, the fourth wheel set 14, the second intermediate shaft 10, and the fifth wheel set 25 to the output shaft 3.

In the seventh gear, the torque is conducted from the driveshaft 2 via the first clutch 6, the first transmission input shaft 4, and the shiftable clutch 31 directly to the output shaft 3. The seventh gear is thus the “direct gear.”

The gears eight, nine are so-called overdrive gears. In the eighth gear, the torque is conducted from the driveshaft 2 via the second clutch 7, the third wheel set 13, the second intermediate shaft 10, and the sixth wheel set 26 to the output shaft 3.

In the ninth gear, which is also an overdrive gear, the torque flows from the driveshaft 2 via the first clutch 6, the first transmission input shaft 4, the second wheel set 12, the first intermediate shaft 9, and the sixth wheel set 26 to the output shaft 3.

FIG. 12 shows the torque flow when the reverse gear is selected. In the reverse gear, the torque is transmitted from the driveshaft 2 via the second clutch 7, the second transmission input shaft 5, and the gearwheel 22 to the gearwheel 38 and from there via the shiftable clutch 41 to the shaft 39 and the gearwheel 40. The torque is transmitted from the gearwheel 40 via the gearwheel 16 to the first intermediate shaft 9 and from there via the shiftable clutch 32 to the second intermediate shaft 10. The torque is transmitted from the second intermediate shaft 10 via the seventh wheel set 27 to the output shaft 3.

As can be seen from FIGS. 3-11, the torque is always transferred from the first clutch to the second clutch 7, or vice versa, while sequentially shifting up or sequentially shifting down, which allows shifting without interruption of traction.

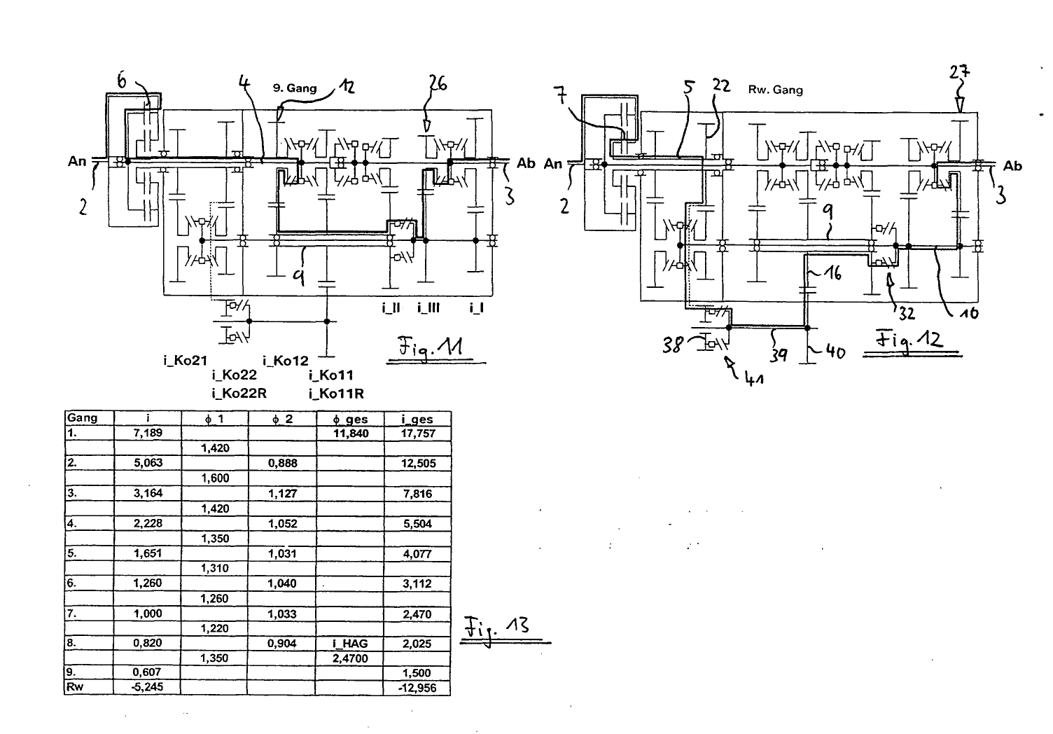

The gear ratios i for the individual gears 1-9 and Rw of the exemplary embodiment are shown in the second column of the table illustrated in FIG. 13. The step jump φ1 for the individual gears is shown in the third column. As already noted, the first gear is a creep gear and the gears eight and nine are overdrive gears. In normal driving operation, one shifts between the gears two through seven. One of the overdrive gears eight or nine is to be selected when traveling at full engine load, but not at the highest velocity.

An essential advantage of the exemplary double-clutch transmission of FIG. 1 is that a strictly progressive step jump may be represented for the gearwheel steps two through seven, i.e., for the normal operating gears. Therefore, when shifting up, the step jump thus always decreases. For example, the step jump from the second into the third gear is 1.6, the step jump from the third into the fourth gear is 1.42, from the fourth into the fifth gear is 1.35, from the fifth into the sixth gear is 1.31, from the sixth into the seventh gear is 1.26, and from the seventh into the eighth gear is 1.22. A progressive step jump curve of this type is very advantageous both from an energetic aspect and also in regard to the shifting comfort.

It is to be expressly noted that the progressivity described solely represents one possible exemplary embodiment. Other progressivity curves may also be selected for the gears 2-7.

As already explained, manifold gears may be represented using the double-clutch transmission of FIG. 1. In particular, the number of the gears (nine forward gears and one reverse gear) is greater than the number of the wheel set levels. In the exemplary embodiment shown in FIG. 1, nine forward gears and one reverse gear may be shifted into by using only seven wheel sets. The double-clutch transmission of FIG. 1 is thus constructed very compactly.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A double-clutch transmission for vehicles having a driveshaft and an output shaft, comprising:
a first transmission input shaft;
a second transmission input shaft, comprising a hollow shaft, the first transmission input shaft being disposed within the second transmission input shaft;
a first clutch rotationally coupling the driveshaft to the first transmission input shaft when closed;
a second clutch rotationally coupling the driveshaft to the second transmission input shaft when closed;
first, second, third, and fourth gearwheel steps; and
an intermediate drive, driven as a function of a shift state of the gearwheel steps by one of the first and the second transmission input shafts via one of the gearwheel steps,
wherein the first transmission input shaft is assigned to the first and to the second gearwheel steps, and the second transmission input shaft is assigned to the third and to the fourth gearwheel steps.

2. The double-clutch transmission according to claim 1, wherein the intermediate drive comprises a first intermediate shaft having a hollow shaft and a second intermediate shaft extending through the hollow first intermediate shaft.

3. The double-clutch transmission according to claim 2, wherein, as a function of the shift state of the first and second gearwheel steps, the first transmission input shaft is one of coupled to one of the first and second intermediate shafts via one of the first and the second gearwheel steps, and rotatable freely in relation thereto.

4. The double-clutch transmission according to claim 3, wherein the first transmission input shaft is coupleable to the first intermediate shaft via one of the first and second gearwheel steps.

5. The double-clutch transmission according to claim 2, wherein, as a function of the shift state of the third and fourth gearwheel steps, the second transmission input shaft is one of coupled via one of the third and the fourth gearwheel steps to one of the first and second intermediate shafts, and rotatable freely in relation thereto.

6. The double-clutch transmission according to claim 5, characterized in that the second transmission input shaft is coupleable via one of the third and fourth gearwheel step to the second intermediate shaft.

7. The double-clutch transmission according to claim 2, further comprising an intermediate shaft clutch having an opened shift state and a closed shift state, wherein the first and second intermediate shafts are rotationally coupled to one another when the intermediate shaft clutch is in the closed shift state.

8. The double-clutch transmission according to claim 2, further comprising at least one first shiftable output-side gearwheel step, for coupling the first intermediate shaft to the output shaft.

9. The double-clutch transmission according to claim 2, further comprising at least one second shiftable output-side gearwheel step, for coupling the second intermediate shaft to the output shaft.

10. The double-clutch transmission according to one of claim 3, wherein, as a function of the shift state of the third and fourth gearwheel steps, the second transmission input shaft is one of coupled via one of the third and the fourth gearwheel steps to one of the first and second intermediate shafts, and rotatable freely in relation thereto.

11. The double-clutch transmission according to claim 10, characterized in that the second transmission input shaft is coupleable via one of the third and fourth gearwheel step to the second intermediate shaft.

12. The double-clutch transmission according to claim 7, further comprising at least one first shiftable output-side gearwheel step, for coupling the first intermediate shaft to the output shaft.

13. The double-clutch transmission according to claim 7, further comprising at least one second shiftable output-side gearwheel step, for coupling the second intermediate shaft to the output shaft.

14. The double-clutch transmission according to claim 2, further comprising two second shiftable output-side gearwheel steps, each coupling the second intermediate shaft to the output shaft.

15. A double clutch transmission, comprising:
a first transmission input shaft connectable to a driveshaft via a first clutch;
a second transmission input shaft connectable to the driveshaft via a second clutch;
first and second gearwheel steps operatively connectable to the first input transmission shaft;
third and fourth gearwheel steps operatively connectable to the second input transmission shaft; and
an intermediate drive selectively connectable to one of the first and second transmission input shafts and to the output shaft in response to a shift state of the first, second, third and fourth gearwheel steps.

16. The double clutch transmission according to claim 15, wherein one of the first and second input transmission shafts is disposed coaxially within the hollow other one.

17. The double clutch transmission according to claim 15, further comprising an intermediate shaft clutch of the intermediate drive, for selectively connecting to the output shaft.

18. The double clutch transmission according to claim 15, further comprising first and second intermediate shafts of the intermediate drive.

19. The double clutch transmission according to claim 18, further comprising a first output side gearwheel step for coupling the first intermediate shaft to the output shaft.

20. The double clutch transmission according to claim 18, further comprising a second output side gearwheel step for coupling the second intermediate shaft to the output shaft.
